(19) United States
(12) Patent Application Publication
(10) Pub. No.: US 2011/0062210 A1
(43) Pub. Date: Mar. 17, 2011

(54) TWO-STAGE, FLAT CLINCHING STAPLER

(76) Inventor: CHAN SIU LEUNG, Kowloon (HK)

(21) Appl. No.: 12/561,548

(22) Filed: Sep. 17, 2009

(51) Int. Cl. B25C 5/02; B25C 5/11

(52) U.S. Cl. 227/120; 227/155; 227/156

(57) ABSTRACT

A stapler comprises a mechanism to first fully drive staples into sheets of materials, e.g., paper, and only then to fold over the legs of the staples. This results in a flat clinch and very few crumpled staples. An anvil table is locked in a raised position above a staple anvil, and a trigger mechanism will operate only when a staple blade has proceeded through a staple magazine and forced a staple fully out. The trigger mechanism slides back when this happens, and unlocks the anvil table so it can drop down around a staple-leg-folding anvil. The whole top of the stapler and the papers being stapled drop with the already fully inserted staple onto the anvil to fold the staple legs over flat.

### BACKGROUND OF THE INVENTION

1. Field of the Invention

The present invention relates to paper staplers, and in particular to staplers that reduce staple malfunctions by driving the staples through the papers first, and then folding the staple legs over flat.

2. Description of the Prior Art

Conventional staplers sometimes need considerable pressure applied by hand to bind a stack of papers together with a staple, and frequently the staples crumple and fail to penetrate. One reason is the staple anvils are directly underneath the papers and the staples must begin folding into a clinch before they have completely penetrated the stack. It would be better to first drive the staples completely through the stack, and only then fold the staple ends over with an anvil to clinch the binding.

### SUMMARY OF THE INVENTION

Briefly, a stapler embodiment of the present invention comprises a mechanism to first fully drive staples into sheets of materials, e.g., paper, and only then fold over the legs of the staples. This results in a flat clinch and very few crumpled staples. An anvil table is locked in a raised position above the anvil, and a trigger mechanism operates only when a staple blade has fully proceeded through a staple magazine and forced out a staple. The trigger mechanism slides back and unlocks the anvil table so it can drop down around a staple-leg-folding anvil. The whole top of the stapler and the papers being stapled drop with the already fully inserted staple onto the anvil to fold the staple legs over flat.

These and other objects and advantages of the present invention will no doubt become obvious to those of ordinary skill in the art after having read the following detailed description of the preferred embodiments that are illustrated in the various drawing figures.

### IN THE DRAWINGS

FIGS. 1A-1D are top-right, top-left, left, and top side perspective views, respectively, of a stapler embodiment of the present invention;

FIG. 2 is an exploded assembly view diagram of the stapler of FIGS. 1A-1D; and

FIGS. 3A-3C are partial cutaway and cross-sectional view diagrams of the stapler of FIGS. 1A-1D and 2, showing the stapler only and no staples in a relaxed state in FIG. 3A, a staple fully penetrated state in FIG. 3B where the anvil table has not yet dropped around the staple anvil, and a staple completion state in FIG. 3C in which the anvil table has completely dropped around the staple anvil and the staple legs are folded over flat.

### DETAILED DESCRIPTION OF THE PREFERRED EMBODIMENT

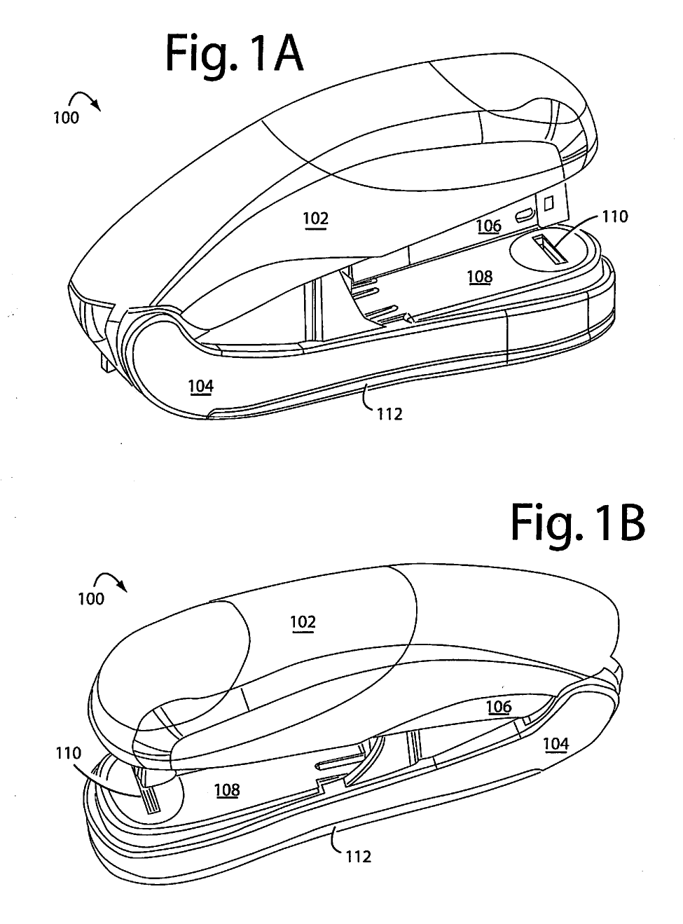

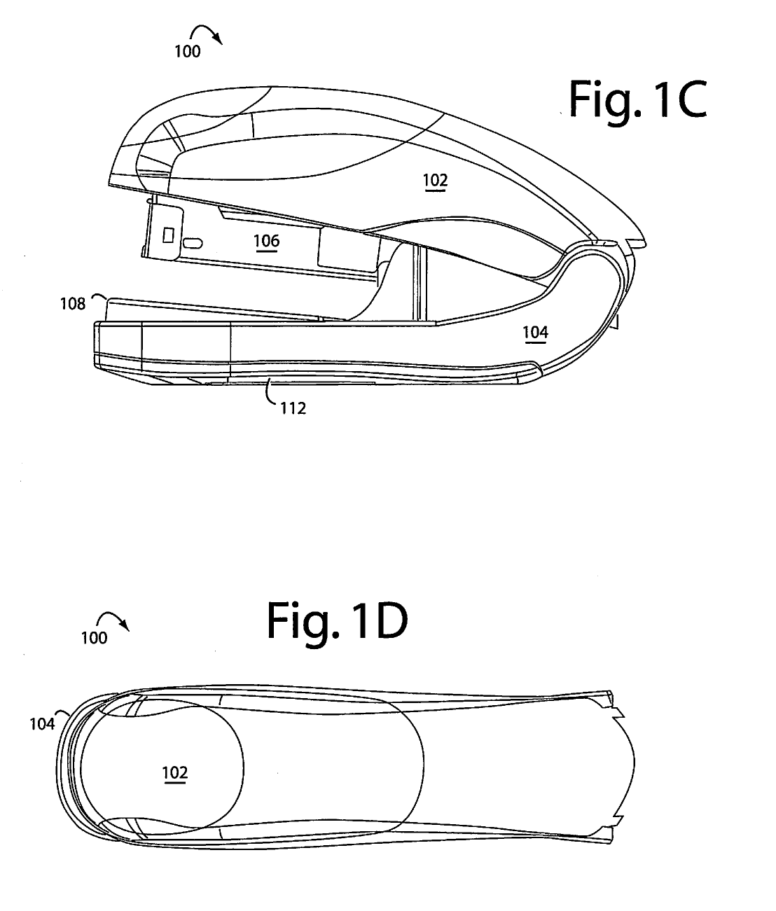

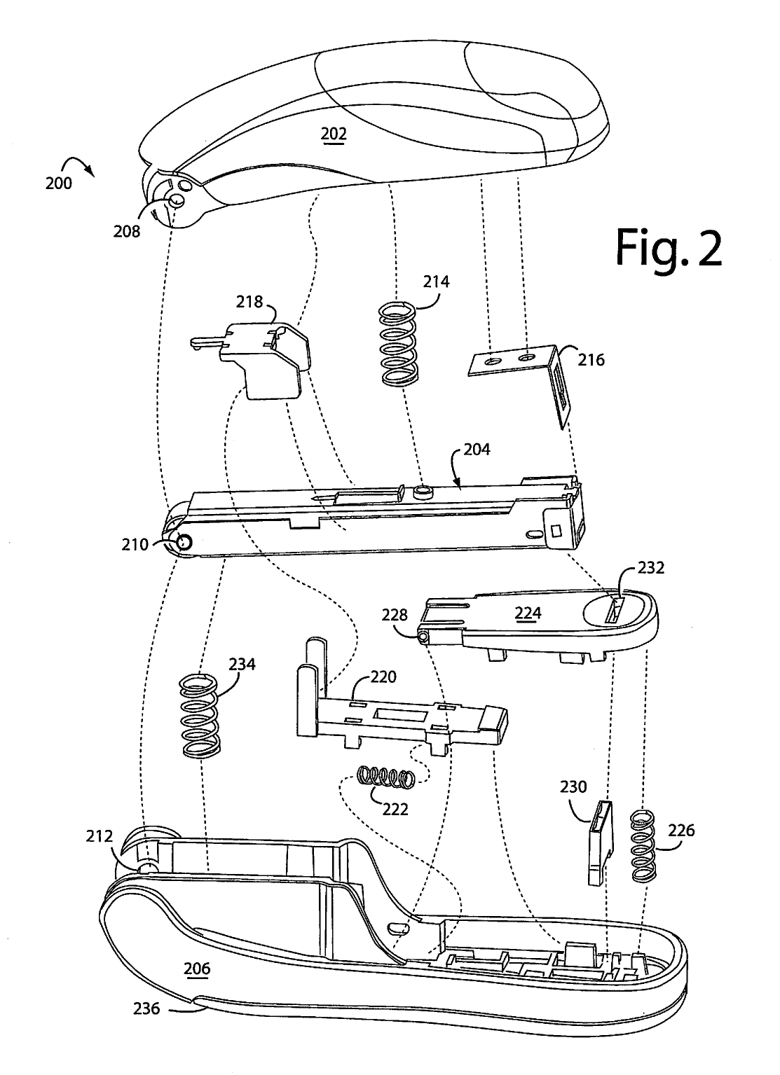

FIGS. 1A-1D show a two-stage, flat-clinch stapler embodiment of the present invention that is referred to herein by the general reference numeral 100. Stapler 100 has a familiar form and function, and comprises a handle 102 hinged at the back to a base 104. Forward and inside of handle 102 is a staple magazine 106 that can be pressed down with handle 102 against an anvil table 108. FIGS. 1A-1C show anvil table 108 in its raised position. An anvil gate 110 is open and allows the legs of staples to freely proceed downward as they pass through a stack of materials, e.g., papers being stapled together. Only after the staples have completely penetrated will the anvil table 108 be triggered to drop anvil gate 110 down around an anvil (shown in FIG. 2). A rubber footing 112 provides for a non-slip bottom surface.

FIG. 2 represents a stapler 200 showing how the stapler of FIG. 1 can be assembled to provide the two-stage, flat-clinch stapling function. Stapler 200 comprises a handle 202 and a staple magazine 204 that attach at the back of a base 206, e.g., with common hinges 208, 210, and 212. A top spring 214 allows a staple blade 216 to retract from staple magazine 204 so a next staple can be forcefully ejected and pushed down and out to penetrate a stack of papers. A slider 218 shuttles back and forth on the top of staple magazine 204, and its rearward motion provides a trigger needed to allow the anvil table, e.g., 108 in FIG. 1, to drop so the legs of the staples can be folded.

The rearward motion of slider 218 will catch the two vertical posts of a trigger shuttle 220 and force it back against a shuttle spring 222 in the base 206. When the trigger shuttle 220 is forced back far enough, the front end of an anvil table 224 will unlock from its raised position and table spring 226 can be compressed.

Anvil table 224 has a pivot 228 that allows it to snap into base 206. An anvil 230 will protrude through an anvil gate 232 when anvil table 224 is triggered to drop. Such trigger occurs only when a staple has fully penetrated, and anvil 230 can fold the staple legs flat over rather than curling them over as is a common case in conventional staplers. A main spring 234 keeps the stapler throat open to receive papers to be stapled when pressure to handle 202 is relaxed. A rubber footing 236 provides a non-slip bottom surface for base 206.

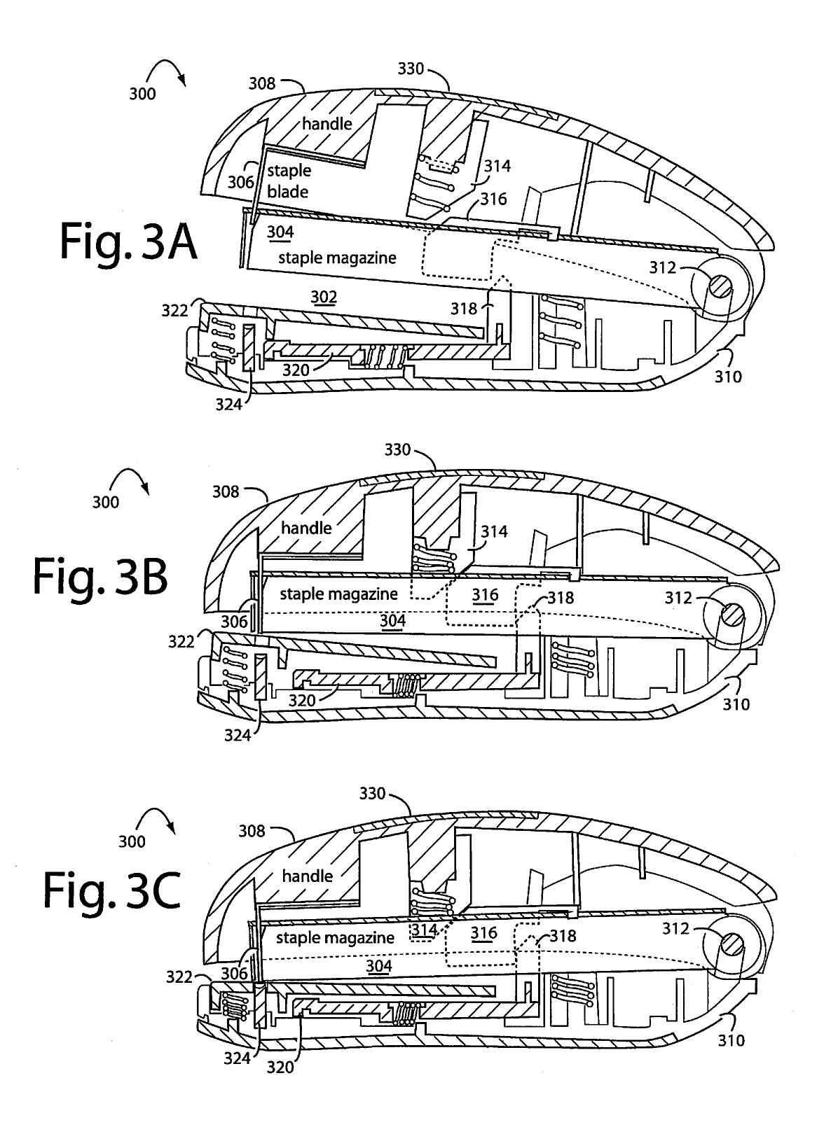

FIGS. 3A-3C are a series that show a stapler 300 at rest, having driven a staple through, and having folded over the legs of the staple. The sheets of paper or material being stapled, and the staple itself, are not shown so that the inter-relationships amongst the parts of the stapler can better be illustrated and described. A throat 302 is open in FIG. 3A to receive sheets of paper for stapling. A staple magazine 304 holds a familiar stick of staples. Each of those staples are separated and driven down and out by a staple blade 306 mounted up inside the front of a handle 308. The handle 308 and staple magazine 304 are attached to a base 310 at the rear with a hinge 312.

In FIG. 3B, a cam 314 up inside handle 308 has come down just enough to contact a slider 316 and push it back toward hinge 312. Since throat 302 is now closed, two legs hanging down from slider 316 can contact a pair of vertical posts 318 on a trigger shuttle 320. However, before trigger shuttle 320 is pushed all the way back, its front end locks an anvil table 322 up in its raised position. This allows a staple to be driven completely down by staple blade 306, and the legs of the staple cannot yet contact an anvil 324.

In FIG. 3C, continued downward pressure on handle 308 has resulted in trigger shuttle 320 being pushed all the way back toward hinge 312. Anvil table 322 is free to drop down around anvil 324. Staple blade 306 and the whole top of stapler 300 follow this drop down and that forces the legs of the staple to be folded over flat by anvil 324.

A top cover 330 may be comprised of a transparent plastic material and used to hold and display graphics and/or messages.

In general, the component pieces of the various stapler embodiments of the present invention are configured to be snapped together for quick and easy assembly.

In summary, a method of stapling sheets of material begins by elevating an anvil table to support a number of sheets of material until a staple has been driven completely through. The anvil table provides clearance for the legs of the staple to penetrate. In a first stage of operation, each staple is ejected from a staple magazine and fully driven into the sheets of material in response to hand pressure applied by a user. In a second stage of operation, the anvil table, staple, and sheets of material drop down with such force that an anvil brought into contact with the staple legs folds them over flat. This clinches the staples only after they have been driven completely through the sheets of material.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A stapler, comprising:
a first stage mechanism to fully drive staples into sheets of papers; and
a second stage mechanism to fold over the legs of a staple flat only after the first stage mechanism has fully driven said staple into said sheets of papers;
wherein, a flat clinch of the staples results.

2. The stapler of claim 1, further comprising:
means for ejecting a staple from a staple magazine while at the same time using hand pressure from a user to drive said staple through a number of sheets of material;
means for elevating an anvil table to support said sheets of material until said staple has been substantially driven completely through, and providing clearance for the legs of said staple to penetrate; and
means for waiting until after said staple has been substantially driven completely through said sheets of material, and for dropping said anvil table, said staple, and said sheets of material down with such force that an anvil is brought into contact with said staple legs and folds them over flat to clinch said staple.

3. The stapler of claim 2, further comprising:
means for locking and unlocking said anvil table in a raised position above said anvil; and
means for unlocking said anvil table so it can drop down around said anvil.

4. A stapler, comprising:
a handle with a cam inside, a hinge at its rear end, and a staple blade at its front end;
a staple magazine with a hinge at its rear end connected to the handle, and providing for the ejecting of a staple each time said staple blade enters at its front;
a base with a hinge at its rear end connected to both the handle and staple magazine, a staple-folding anvil, and an anvil table that can be locked and unlocked in a raised position above said staple-folding anvil;
a trigger mechanism connected between said cam and said anvil table, and providing for an unlocking of said anvil table to drop down around said staple-folding anvil;
wherein, the trigger mechanism provides timing for said unlocking of said anvil table to drop down.

5. The stapler of claim 4, the trigger mechanism further comprising:
a slider mounted to the staple magazine for contacting said cam and translating that into a rearward movement as said staple blade moves into the staple magazine to eject a staple.

6. The stapler of claim 5, the trigger mechanism further comprising:
a trigger shuttle mounted in the base beneath said anvil table and having vertical posts to receive said rearward movement of said slider.

7. The stapler of claim 6, wherein:
said trigger shuttle is configured to unlock said anvil table from its raised position as a result of said rearward movement of said slider.

8. The stapler of claim 4, further comprising:
an anvil gate through which can protrude said staple-folding anvil when said anvil table is unlocked.

9. The stapler of claim 7, further comprising:
a table spring for raising said anvil table to a locked position;
a main spring for raising the staple magazine up from the base;
a top spring for raising the handle up from the staple magazine; and
a shuttle spring for pushing said trigger shuttle forward to lock said anvil table in its raised position.

10. The stapler of claim 4, further comprising:
a top cover mounted to the handle and comprised of a transparent plastic material, and suitable for holding and displaying graphics and/or messages.

11. A method of stapling sheets of material, comprising:
elevating an anvil table to support a number of sheets of material until said staple has been substantially driven completely through, and providing clearance for the legs of said staple to penetrate;
ejecting a staple from a staple magazine and fully driving said staple into said sheets of material in response to hand pressure applied by a user; and
dropping said anvil table, said staple, and said sheets of material down with such force that an anvil is brought into contact with said staple legs and folds them over flat to clinch said staple only after said staple has been substantially driven completely through said sheets of material.
